(19) United States
(12) Patent Application Publication
(10) Pub. No.: US 2026/0361677 A1
(43) Pub. Date: Nov. 12, 2026

(54) System and Method of User Equipment Authentication for Enterprise Network Access Using Network Address Translation of Dynamic IP Addresses to Static IP Addresses

(71) Applicant: T-Mobile Innovations LLC, Overland Park, KS (US)

(72) Inventors: Anis Adil ANIS, Bay Point, CA (US); Cristian ASANDULUI, Snoqualmie, WA (US); Tamas FELKER, Woodinville, WA (US); Brent Matthew JOHNSTON, Ardmore, AL (US); Senthil Kumar KALIAPPAN, Sammamish, WA (US); Sagar Satish VANJARI, Aldie, VA (US); Nathan WILHOFT, Shawnee, KS (US)

(21) Appl. No.: 19/200,616

(22) Filed: May 6, 2025

(51) Int. Cl. H04L 61/2503; H04L 61/5014; H04L 61/5061

(52) U.S. Cl. CPC H04L 61/2503; H04L 61/5014; H04L 61/5061

(57) ABSTRACT

A system for UE authentication for enterprise network access comprises a telecommunication server that provides one or more pools of static IP addresses to a gateway, a core network comprising a UPF that assigns dynamic IP addresses to UEs associated with an enterprise network, and the gateway. The gateway comprises a NAT function, one or more security elements, and a memory that stores the pool(s) and mappings of the dynamic IP addresses to static IP addresses from the pool(s) for the UEs. The gateway receives a message via a static IP address from an enterprise system intended for one of the UEs, applies at least one of the security element(s) to the message, translates, by the NAT function, the static IP address to a dynamic IP address based on the stored mappings, and transmits, via the core network and the dynamic IP address, the message to the intended UE.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

An internet protocol (IP) address is a unique number assigned to a device that is connected to a computer network. The device uses the IP address for communication. There are two different versions or standards for IP addresses—Internet Protocol version 4 (IPv4) and Internet Protocol version 6 (IPv6). There are different types of IP addresses including dynamic IP addresses, static IP addresses, public IP addresses, and private IP addresses. A dynamic IP address changes periodically (e.g., at certain intervals or when the device disconnects and reconnects to a network) while a static IP address is an unchanging IP address. A public IP address can be accessed directly over the internet while a private IP address is used within a private network and are not accessible from the internet. Network address translation (NAT) is a service that allows private IP addresses to use the internet by changing or translating the internal IP address from a private local IP address to a public IP address.

### SUMMARY

In an embodiment, a system for user equipment (UE) authentication for enterprise network access is disclosed. The system comprises a telecommunication server configured to provide one or more pools of static internet protocol (IP) addresses to a gateway and a core network comprising a user plan function (UPF). The UPF assigns dynamic IP addresses to UEs associated with an enterprise network. The system also comprises the gateway. The gateway comprises a network address translation (NAT) function, one or more security elements, and a non-transitory memory that stores the one or more pools of static IP addresses and mappings of the dynamic IP addresses to static IP addresses from the one or more pools of static IP addresses for the UEs. The gateway is configured to receive a message via a static IP address from an enterprise system on the enterprise network intended for a UE associated with the enterprise network. The stored mappings associate the static IP address with the UE. The gateway is further configured to apply at least one of the one or more security elements to the message, translate, by the NAT function, the static IP address to a dynamic IP address based on the stored mappings, and transmit, via the core network and the dynamic IP address, the message to the UE.

In another embodiment, a method of user equipment (UE) authentication for enterprise network access is disclosed. The method comprises providing, by a telecommunication server, one or more pools of static internet protocol (IP) addresses to a gateway, assigning, by a user plane function of a core network, a first dynamic IP address to a first UE associated with an enterprise network and a second dynamic IP address to a second UE associated with the enterprise network, and receiving, by the gateway via the core network, a message sent by the first UE and intended for the second UE. The method also comprises translating, by a network address translation (NAT) function on the gateway, the first dynamic IP address to a first static IP address from the one or more pools of static IP addresses and the second dynamic IP address to a second static IP address from the one or more pools of static IP addresses based on stored mappings of the first dynamic IP address to the first static IP address and the second dynamic IP address to the second static IP address, and applying, by the gateway, one or more security elements to the message based on the first and second static IP addresses. The method further comprises subsequently translating, by the NAT function, the second static IP address to the second dynamic IP address based on the stored mappings, and transmitting, by the gateway via the core network and the second dynamic IP address, the message to the second UE.

In yet another embodiment, a method of user equipment (UE) authentication for enterprise network access is disclosed. The method comprises providing, by a telecommunication server, one or more pools of static internet protocol (IP) addresses to a gateway, assigning, by a user plane function of a core network, a dynamic IP address to a UE associated with an enterprise network, and receiving, by the gateway via the core network, a message sent by the UE and intended for an enterprise system on the enterprise network. The method also comprises mapping, by a network address translation (NAT) function on the gateway, the dynamic IP address to a static IP address from the one or more pools of static IP addresses, storing, by the gateway, the mapping of the dynamic IP address to the static IP address, and applying, by the gateway, one or more security elements to the message. The method additionally comprises subsequently transmitting, by the gateway, the message to the enterprise system via the static IP address and receiving, by the gateway, a response from the enterprise system via the static IP address. The method further comprises translating, by the NAT function, the static IP address to the dynamic IP address based on the stored mapping, and transmitting, by the gateway via the core network and the dynamic IP address, the response to the UE.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system according to an embodiment of the disclosure.

FIG. 2 is a flow chart of a method according to an embodiment of the disclosure.

FIG. 3 is a flow chart of another method according to an embodiment of the disclosure.

FIG. 4A and FIG. 4B is a block diagram of a communication system according to an embodiment of the disclosure.

FIG. 5 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Telecommunication service providers provide dynamic internet protocol (IP) addresses to user equipment (UEs) to connect to and communicate on their network. Telecommunication service providers may provide service to enterprises and UEs associated with those enterprises. Systems and services exist that provide security elements for traffic flowing into and out of private networks such as enterprise networks. The enterprise, as a customer of the telecommunication service provider, may wish to allow communication between UEs associated with the enterprise and enterprise systems on the enterprise network via the core network as well as communication between such UEs via the core network while maintaining security over access to the enterprise network and the communications flowing into and out of the enterprise network as well as promoting traceability of such enterprise network access.

The pending application is directed to an approach to user equipment (UE) authentication for enterprise network access that uniquely leverages more dynamic IP address based systems without modifying the core network. In particular, the pending application leverages these more dynamic IP address based systems, but uses a combination of static IP addresses and a network address translation (NAT) function for enterprise network access. The NAT function may occur on the same gateway where the security elements are imposed on the communication traffic attempting to enter or exit the enterprise network. The gateway may provide services to one or more enterprise customers.

The telecommunication service provider may define a pool of dynamic IP addresses to be used for UEs associated with a particular enterprise customer. For example, a user plane function (UPF) on the core network of the telecommunication service provider may assign a dynamic IP address from the pool of dynamic IP address to a UE associated with the enterprise network of the particular enterprise customer. The association of the UE with the enterprise of the particular enterprise customer may be by way of a subscriber identity module (SIM) on the UE. This assigned dynamic IP address may be used for the UE's communications flowing through the core network. In some cases, periodically an updated dynamic IP address from the pool of dynamic IP addresses may be assigned to the UE and used for the UE's communications flowing through the core network.

One or more pools of static IP addresses may be provided to the gateway. For example, a telecommunication server of the telecommunication service provider may provide the one or more pools of static IP addresses to the gateway. The one or more pools of static IP addresses may be defined by the particular enterprise customer. A user of the UE may want to access an enterprise system such as to perform maintenance or access records, logs, or other data from the enterprise network and may therefore send a message intended for the enterprise system of the enterprise network. When the gateway receives the message from the UE intended for the enterprise system of the enterprise network, the NAT function on the gateway maps the dynamic IP address to a static IP address from the one or more pools of static IP addresses for the particular enterprise customer and stores that mapping. The assigned static IP address may be used for communications associated with the UE flowing through enterprise network.

The gateway may also apply one or more security elements to the message and then transmit the message to the enterprise system via the static IP address. The security element(s) may execute content filtering, malware screening, domain name system (DNS) filtering, predefined security rules, or some other security process. The gateway may receive a response from the enterprise system via the static IP address. The gateway may apply one or more security elements to the response. The NAT function on the gateway may translate the static IP address to the dynamic IP address based on the stored mapping. The gateway may then transmit the response to the UE via the core network and the dynamic IP address.

As will be discussed further below, in addition to communication flowing into the enterprise network, the approach to UE authentication for enterprise network access disclosed herein may be used for communication flowing from the enterprise to a UE associated with the enterprise network, thereby enabling the enterprise network to access the UE using the associated static IP address. Additionally, the approach to UE authentication for enterprise network access disclosed herein may be used for communication between UEs associated with the enterprise network. In some cases, the gateway may support more than one enterprise customer. In such cases, duplicated static IP addresses can be supported for different enterprise domains. Stated differently, there may be overlapping static IP addresses for two or more enterprise customers. When the gateway supports more than one enterprise customer, after leaving the gateway, communications may flow to a customer specific intermediate gateway before reaching the intended enterprise system. While described above and below as an enterprise network and an enterprise system, other private networks and private systems not necessarily tied to an enterprise are contemplated with departing from the spirit or scope of the present disclosure.

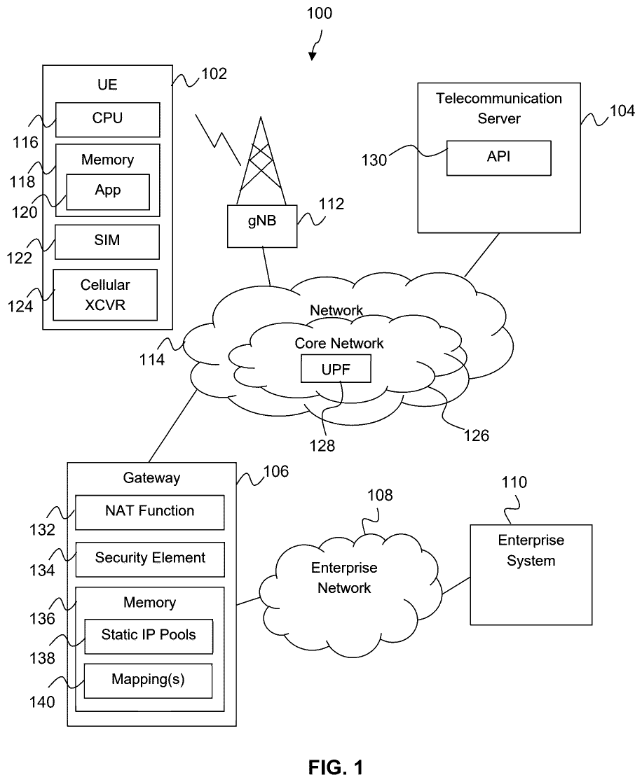

Turning now to FIG. 1, a system 100 is described. In an embodiment, the system 100 comprises a user equipment (UE) 102, a telecommunication server 104, a gateway 106, an enterprise network 108, an enterprise system 110, a cell site 112, and a network 114. The UE 102 may be a mobile phone, a smart phone, a personal digital assistant (PDA), a wearable computer, a headset computer, a laptop computer, a notebook computer, a tablet computer, or another device. The UE 102 may comprise a processor 116, a memory 118, an application 120 stored in the memory 118, a subscriber identity module (SIM) 122, and a cellular radio transceiver 124. The UE 102 may be associated with the enterprise network 108 via the SIM 122. For example, the UE 102 may be associated with the enterprise network 108 via an identifier (e.g., an International Mobile Subscriber Identity (IMSI), a Mobile Station International Subscriber Directory Number (MSISDN), etc.) stored in the SIM 122. The UE 102 may communicate with the enterprise network 108 using the application 118.

The cellular radio transceiver 124 may be configured to establish a wireless communication link with the cell site 112. In an embodiment, the cellular radio transceiver 124 is able to establish a wireless communication link with the cell site 112 according to a 6G, a 5G, a long-term evolution (LTE), a code division multiple access (CDMA), or a global system for mobile communications (GSM) telecommunication protocol. The cell site 112 may communicatively couple the UE 102 to the network 114 and therethrough to other UEs, application servers, content servers, and the like. It will be understood that the system 100 may comprise any number of UEs 102, any number of cell sites 112, any number of enterprise networks 108, and/or any number of enterprise systems 110.

In an embodiment, the network 114 comprises one or more public networks, one or more private networks, or a combination thereof. The network 114 may comprise a core network 126. In an embodiment, the core network 126 comprises a user plane function (UPF) 128. The UPF 128 may assign a dynamic internet protocol (IP) address to the UE 102. The dynamic IP address assigned to the UE 102 may be selected from a pool of dynamic IP addresses designated by a telecommunication service provider for UEs associated with the particular enterprise customer associated with the enterprise network 108. The assigned dynamic IP address may be used for the UE's 102 communications flowing through the core network 126.

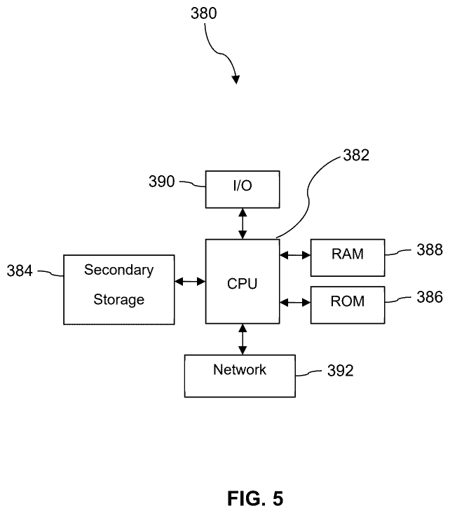

The telecommunication server 104 is associated with the telecommunication service provider. The telecommunication server 104 may comprise an application programming interface (API) 130. The API 130 may be used to manage the pools of static IP addresses provided to the gateway 102 as well as manage deprovisioned SIMs associated with the enterprise network 108. The telecommunication server 104 may be a computer system. Computer systems are discussed below in reference to FIG. 5.

In an embodiment, the gateway 106 comprises a network address translation (NAT) function 132, a security element 134, and a memory 136. The gateway 106 may be a computer system. As mentioned above, computer systems are discussed below in reference to FIG. 5. The memory 136 of the gateway 106 may comprise one or more pools of static IP addresses 138. The pool(s) of static IP addresses 138 may be received by the gateway 106 from the telecommunication server 104 such as via the API 130. The pool(s) of static IP addresses 138 may be defined by the particular enterprise customer associated with the enterprise network 108. The gateway 106 may store pool(s) of static IP addresses 138 for multiple enterprise customers. For example, there may be one or more pools of static IP addresses for a first enterprise customer and one or more pools of static IP addresses for a second enterprise customer. The one or more pools of static IP addresses for multiple enterprise customers may be different or may comprise overlapping static IP addresses.

In an embodiment, the UE 102 may want to access the enterprise system 110 such as to perform maintenance or access records, logs, or other data from the enterprise network 108 and may therefore send a message intended for the enterprise system 110. In an embodiment, the UE 102 may use the application 120 to transmit the message. In response to the gateway 106 receiving a message from the UE 102 intended for the enterprise system 110, the NAT function 132 may map the dynamic IP address to a static IP address from the pool(s) of static IP addresses 138 for the particular enterprise customer. The gateway 106 may then store the mapping 140 of the dynamic IP address to the static IP address in the memory 136.

The security element 134 may comprise a firewall. The security element 134 may execute content filtering, malware screening, domain name system (DNS) filtering, predefined security rules, or some other security process to communications entering and/or exiting the enterprise network 108. For example, the gateway 106 may apply the security element 134 to the message received from the UE 102. Predefined security rules may comprise restricting access to certain enterprise systems for certain users, restricting access to certain enterprise content for certain users, or other predefined security rules. While only one security element 134 is illustrated in FIG. 1, it will be understood that the gateway 106 may comprise any number of security elements 134.

After the security element 134 is applied to the message, the gateway 106 may transmit the message through the enterprise network 108 via a secure pathway (e.g., a software-defined wide area network (SD-WAN) tunnel, a virtual private network (VPN) tunnel, etc.) to an intermediate gateway or the enterprise system 110 using the static IP address. In an embodiment, the enterprise network 108 comprises one or more private networks. The enterprise system 110 may comprise an enterprise router, an enterprise data center, an enterprise database, or another enterprise component/system.

The enterprise system 110 may send a response via the secure pathway using the static IP address. The gateway 106 may receive the response and translate, via the NAT function 132, the static IP address to the dynamic IP address based on the stored mapping 140. The gateway 106 may also apply the security element 134 or a different security element to the response. The gateway 106 may then transmit the response via the core network 126 and the dynamic IP address to the UE 102. In an embodiment, the UE 102 receives and displays the response via the application 120.

In some cases, the enterprise network 108 may want to access the UE 102 using the associated static IP address. In such cases, the gateway 106 may receive a message from the enterprise system 110. The gateway 106 may apply the security element 134 to the message. The NAT function 132 may translate the IP address to the dynamic IP address based on the mapping 140. The gateway 106 may then transmit the message to the UE 102 via the core network 126 and the dynamic IP address.

In some cases, two UEs associated with the enterprise network 108 may wish to communicate with each other. In such cases, the gateway 106 may receive a message from the UE 102 intended for a second UE (not illustrated in FIG. 1). The NAT function 132 may translate a first dynamic IP address assigned to the UE 102 to a first static IP address from pool(s) of static IP addresses 138 and translate a second dynamic IP address assigned to the second UE to a second static IP address from the pool(s) of static IP address 138 based on the mapping(s) 140. The gateway 106 may apply the security element 134 to the message based on the first and second static IP addresses. The NAT function 132 may subsequently translate the second static IP address to the second dynamic IP address based on the mapping(s) 140. The gateway 106 may then transmit the message to the second UE via the core network 126 and the second dynamic IP address.

On occasion, the dynamic IP address associated with the UE 102 may be updated. In such a case, the UPF 128 may assign an updated dynamic IP address to the UE 102 from the pool of dynamic IP addresses. The UE 102 may send a second message intended for the enterprise system 110. The NAT function 132 may map the updated dynamic IP address to the same static IP address or an updated static IP address from the pool(s) of static IP addresses 138. The gateway 106 may store an updated mapping in the memory 136. The gateway 106 may apply the security element 134 and then transmit the second message to the enterprise system 110 via the assigned static IP address. The gateway 106 may receive a second response from the enterprise system 110 via the associated static IP address. The gateway 106 may apply the security element 134 or a different security element to the second response. In an embodiment, the NAT function 132 translates the associated static IP address to the updated dynamic IP address based on the stored updated mapping. The gateway 106 may then transmit the second response to the UE 102 via the core network 126 and the updated dynamic IP address.

At some point, the UE 102 may no longer be associated with the enterprise network 108 and the SIM 122 may be deprovisioned. In response to the SIM 122 of the UE 102 being deprovisioned, the API 130 of the telecommunication server may delete any identifiers (e.g., an IMSI, a MSISDN, etc.) associated with the SIM 122 from the mapping(s) 140 on the gateway 106. The static IP address associated with the UE 102 in the mapping(s) 140 may then be returned to the pool(s) of static IP addresses 138 for reassignment to another UE associated with the enterprise network 108. In an embodiment, deprovisioned static IP addresses are held for a customer defined time period before being returned to the pool(s) of static IP addresses 138 for reassignment.

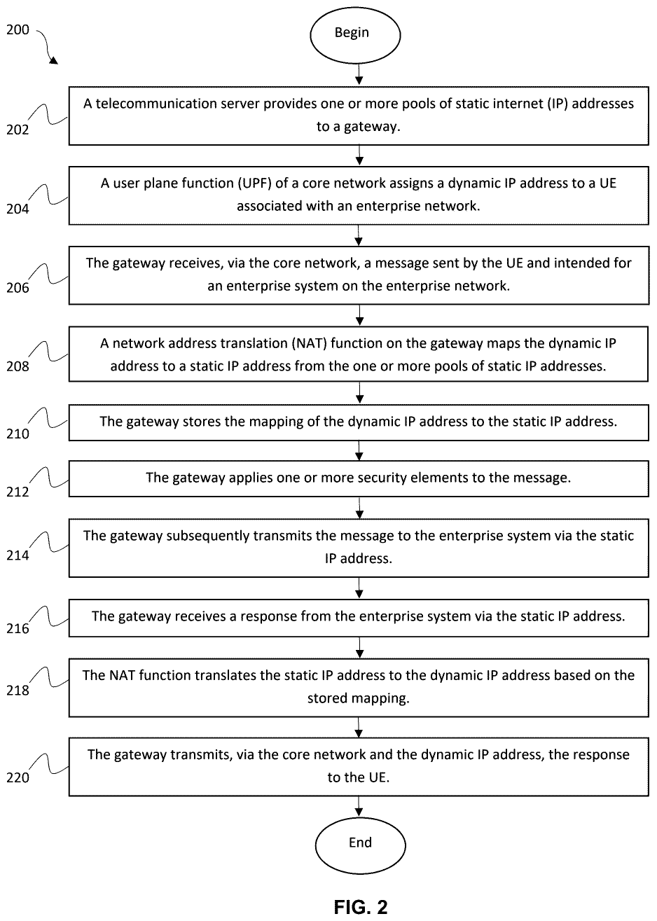

Turning now to FIG. 2, a method 200 is described. In an embodiment, the method 200 is a method of UE authentication for enterprise network access. As illustrated, FIG. 2 includes a number of enumerated operations, but embodiments of the operations in FIG. 2 may include additional operations before, after, and in between the enumerated operations. In some embodiments, one or more of the enumerated operations may be omitted or performed in a different order.

At block 202, a telecommunication server (e.g., telecommunication server 104) provides one or more pools of static IP addresses (e.g., pool(s) of static IP addresses 138) to a gateway (e.g., gateway 106). At block 204, a UPF (e.g., UPF 128) of a core network (e.g., core network 126) assigns a dynamic IP address to a UE (e.g., UE 102) associated with an enterprise network (e.g., enterprise network 108). At block 206, the gateway receives, via the core network, a message sent by the UE and intended for an enterprise system (e.g., enterprise system 110) on the enterprise network. At block 208, a NAT function (e.g., NAT function 132) on the gateway maps the dynamic IP address to a static IP address from the one or more pools of static IP addresses.

At block 210, the gateway stores the mapping (e.g., mapping(s) 140) of the dynamic IP address to the static IP address. At block 212, the gateway applies one or more security elements (e.g., security element 134) to the message. At block 214, the gateway subsequently transmits the message to the enterprise system via the static IP address. At block 216, the gateway receives a response from the enterprise system via the static IP address. At block 218, the NAT function translates the static IP address to the dynamic IP address based on the stored mapping. At block 220, the gateway transmits, via the core network and the dynamic IP address, the response to the UE.

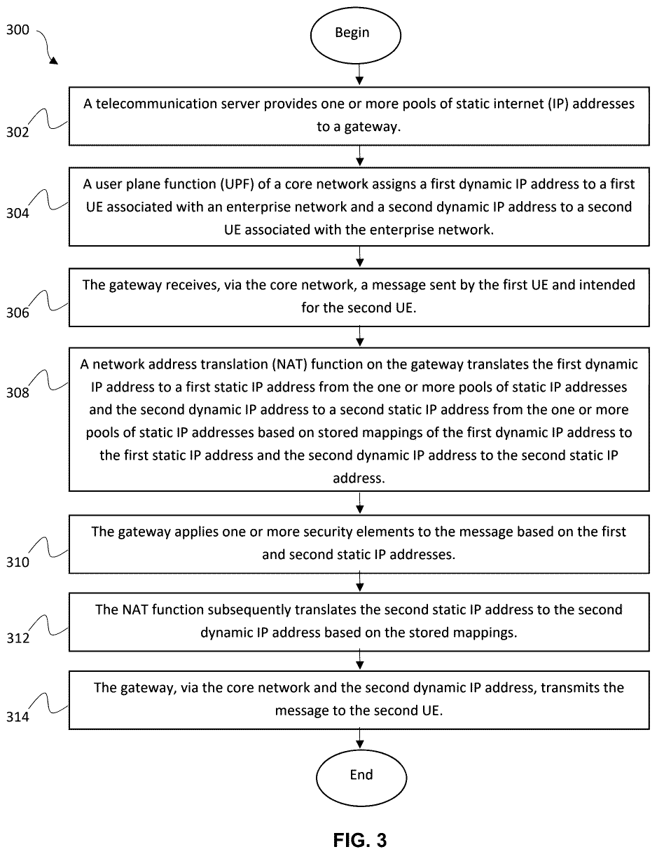

Turning now to FIG. 3, a method 300 is described. In an embodiment, the method 300 is a method of UE authentication for enterprise network access. As illustrated, FIG. 3 includes a number of enumerated operations, but embodiments of the operations in FIG. 3 may include additional operations before, after, and in between the enumerated operations. In some embodiments, one or more of the enumerated operations may be omitted or performed in a different order.

At block 302, a telecommunication server (e.g., telecommunication server 104) provides one or more pools of static internet (IP) addresses e.g., pool(s) of static IP addresses 138) to a gateway (e.g., gateway 106). At block 304, a UPF (e.g., UPF 128) of a core network (e.g., core network 126) assigns a first dynamic IP address to a first UE (e.g., UE 102) associated with an enterprise network (e.g., enterprise network 108) and a second dynamic IP address to a second UE associated with the enterprise network. At block 306, the gateway receives, via the core network, a message sent by the first UE and intended for the second UE.

At block 308, a NAT function (e.g., NAT function 132) on the gateway translates the first dynamic IP address to a first static IP address from the one or more pools of static IP addresses and the second dynamic IP address to a second static IP address from the one or more pools of static IP addresses based on stored mappings (e.g., mapping(s) 140) of the first dynamic IP address to the first static IP address and the second dynamic IP address to the second static IP address. At block 310, the gateway applies one or more security elements (e.g., security element 134) to the message based on the first and second static IP addresses. At block 312, the NAT function subsequently translates the second static IP address to the second dynamic IP address based on the stored mappings. At block 314, the gateway, via the core network and the second dynamic IP address, transmits the message to the second UE.

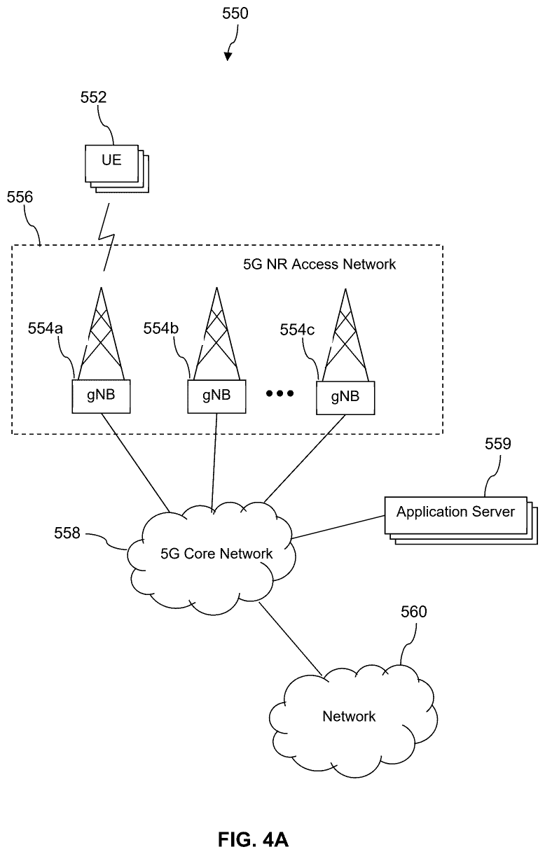

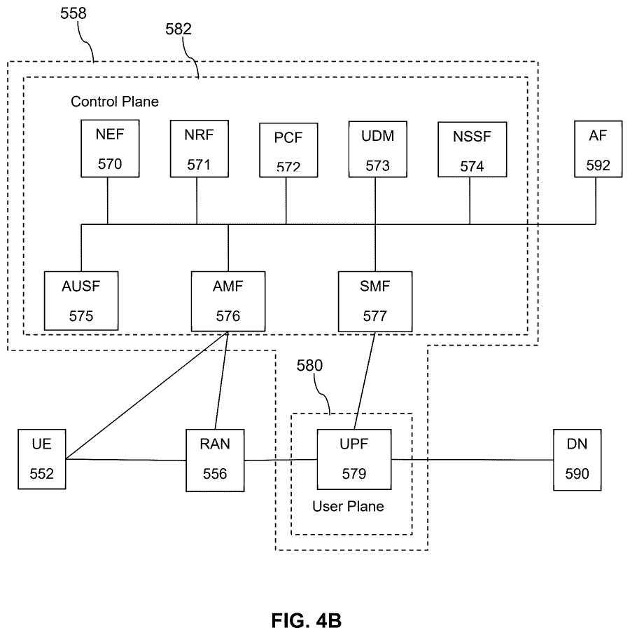

Turning now to FIG. 4A, an exemplary communication system 550 is described. Typically, the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a radio access network (RAN) in some contexts. In a 5G technology generation an access node 554 may be referred to as a next Generation Node B (gNB). In 4G technology (e.g., long-term evolution (LTE) technology) an access node 554 may be referred to as an evolved Node B (eNB). In 3G technology (e.g., code division multiple access (CDMA) and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G” such as Long-Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 4B, further details of the core network 558 are described. In an embodiment, the core network 558 is a 5G core network. 5G core network technology is based on a service-based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 4A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow-based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be execute on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

FIG. 5 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system for user equipment (UE) authentication for enterprise network access, comprising:
a telecommunication server configured to provide one or more pools of static internet protocol (IP) addresses to a gateway;
a core network comprising a user plan function (UPF), wherein the UPF assigns dynamic IP addresses to UEs associated with an enterprise network; and
the gateway comprising a network address translation (NAT) function, one or more security elements, and a non-transitory memory that stores the one or more pools of static IP addresses and mappings of the dynamic IP addresses to static IP addresses from the one or more pools of static IP addresses for the UEs, wherein the gateway is configured to:
receive a message via a static IP address from an enterprise system on the enterprise network intended for a UE associated with the enterprise network, wherein the stored mappings associate the static IP address with the UE,
apply at least one of the one or more security elements to the message,
translate, by the NAT function, the static IP address to a dynamic IP address based on the stored mappings, and
transmit, via the core network and the dynamic IP address, the message to the UE.

2. The system of claim 1, wherein the enterprise network is associated with an enterprise, and wherein the enterprise defines the one or more pools of static IP addresses.

3. The system of claim 1, wherein the UE is associated with the enterprise network via a subscriber identity module (SIM) of the UE.

4. The system of claim 3, wherein the telecommunication server, via an application programming interface, is further configured to delete any identifiers associated with the SIM from the mappings stored on the gateway in response to the SIM of the UE being deprovisioned.

5. The system of claim 4, wherein the gateway is further configured to return the static IP address to the one or more pools of IP addresses for reassignment to another UE associated with the enterprise network.

6. A method of user equipment (UE) authentication for enterprise network access, comprising:
providing, by a telecommunication server, one or more pools of static internet protocol (IP) addresses to a gateway;
assigning, by a user plane function of a core network, a first dynamic IP address to a first UE associated with an enterprise network and a second dynamic IP address to a second UE associated with the enterprise network;
receiving, by the gateway via the core network, a message sent by the first UE and intended for the second UE;
translating, by a network address translation (NAT) function on the gateway, the first dynamic IP address to a first static IP address from the one or more pools of static IP addresses and the second dynamic IP address to a second static IP address from the one or more pools of static IP addresses based on stored mappings of the first dynamic IP address to the first static IP address and the second dynamic IP address to the second static IP address;
applying, by the gateway, one or more security elements to the message based on the first and second static IP addresses;
subsequently translating, by the NAT function, the second static IP address to the second dynamic IP address based on the stored mappings; and
transmitting, by the gateway via the core network and the second dynamic IP address, the message to the second UE.

7. The method of claim 6, wherein the enterprise network is associated with an enterprise, and wherein the enterprise defines the one or more pools of static IP addresses.

8. The method of claim 7, wherein the first dynamic IP address and the second dynamic IP address are selected from a predefined pool of dynamic IP addresses, and wherein the predefined pool of dynamic IP addresses is assigned to the enterprise.

9. The method of claim 6, further comprising:
receiving, by the gateway via the core network, a second message sent by the first UE and intended for an enterprise system on the enterprise network;
translating, by the NAT function, the first dynamic IP address to the first static IP address based on the stored mappings;
applying, by the gateway, the one or more security elements to the second message;
subsequently transmitting, by the gateway, the second message to the enterprise system via the first static IP address;
receiving, by the gateway, a response from the enterprise system via the first static IP address;
translating, by the NAT function, the first static IP address to the first dynamic IP address based on the stored mappings; and
transmitting, by the gateway via the core network and the first dynamic IP address, the response to the first UE.

10. The method of claim 9, wherein the enterprise system comprises at least one of an enterprise router or an enterprise data center.

11. The method of claim 6, wherein the first UE is associated with the enterprise network via a subscriber identity module (SIM) of the first UE and the second UE is associated with the enterprise network via a subscriber identity module (SIM) of the second UE.

12. The method of claim 11, further comprising:
in response to the SIM of the first UE being deprovisioned, deleting, via an application programming interface of the telecommunication server, any identifiers associated with the SIM of the first UE from the mappings stored on the gateway; and
subsequently returning the first static IP address to the one or more pools of IP addresses for reassignment to another UE associated with the enterprise network.

13. A method of user equipment (UE) authentication for enterprise network access, comprising:
providing, by a telecommunication server, one or more pools of static internet protocol (IP) addresses to a gateway;
assigning, by a user plane function of a core network, a dynamic IP address to a UE associated with an enterprise network;
receiving, by the gateway via the core network, a message sent by the UE and intended for an enterprise system on the enterprise network;
mapping, by a network address translation (NAT) function on the gateway, the dynamic IP address to a static IP address from the one or more pools of static IP addresses;
storing, by the gateway, the mapping of the dynamic IP address to the static IP address;
applying, by the gateway, one or more security elements to the message;
subsequently transmitting, by the gateway, the message to the enterprise system via the static IP address;
receiving, by the gateway, a response from the enterprise system via the static IP address;
translating, by the NAT function, the static IP address to the dynamic IP address based on the stored mapping; and
transmitting, by the gateway via the core network and the dynamic IP address, the response to the UE.

14. The method of claim 13, wherein the enterprise network is associated with an enterprise, and wherein the enterprise defines the one or more pools of static IP addresses.

15. The method of claim 14, wherein the dynamic IP address is selected from a predefined pool of dynamic IP addresses, and wherein the predefined pool of dynamic IP addresses is assigned to the enterprise.

16. The method of claim 13, wherein the UE is associated with the enterprise network via a subscriber identity module (SIM) of the UE.

17. The method of claim 16, further comprising, in response to the SIM of the UE being deprovisioned, deleting, via an application programming interface of the telecommunication server, any identifiers associated with the SIM from mappings stored on the gateway.

18. The method of claim 17, further comprising subsequently returning the static IP address to the one or more pools of IP addresses for reassignment to another UE associated with the enterprise network.

19. The method of claim 13, wherein the enterprise system comprises at least one of an enterprise router or an enterprise data center.

20. The method of claim 13, wherein the one or more security elements apply one or more of content filtering, malware screening, domain name system (DNS) filtering, or predefined security rules.
